(19) United States
(12) Patent Application Publication
(10) Pub. No.: US 2004/0158550 A1
(43) Pub. Date: Aug. 12, 2004

(54) System and method for cooperate database acceleration

(76) Inventor: Cary Anthony Jardin, San Diego, CA (US)

Correspondence Address: Cary A. Jardin, 12662 Sabre View Cove, San Diego, CA, 92128, US

(21) Appl. No.: 10/345,504

(22) Filed: Jan. 16, 2003

(51) Int. Cl. G06F 17/30

(52) U.S. Cl. 707/2

(57) ABSTRACT

The present invention provides a system to allow existing database applications to delegate costly transactions to a main memory database system while maintaining persistent and coherent storage on the existing database. The system utilizes database heterogeneous transaction support to delegate desired transaction without modification of existing database application logic. Persistency is maintained on the host database by replicating state change operations onto the associated main memory system. In this way, the present invention provides the performance of a main memory database system, with the required persistency of existing database technologies.

### FIELD OF THE INVENTION

The present invention pertains generally to computer databases, and more specifically, to increased performance accomplished by using a traditional database system to provide persistent information storage and a main memory database to provide increased information retrieval speeds.

### BACKGROUND OF THE INVENTION

Over the last twenty years the database server has become a central and critical element of business infrastructure. Businesses rely on the database to be the safe harbor for the storage and retrieval of vital information. This requirement on reliability has produced a substantial problem for the field of computer science; technology can either be reliable, or it can be fast but rarely both. The novelty of the present invention provides the reliability of traditional database systems, with the performance of a main memory database.

Prior technology surrounding the database field is a constant game of give and take; performance can be had at the expense of reliablity. However, before the novelty of the present invention is explored deeper, it is first warranted to describe the fundamental building blocks and prior technologies.

The field of database technology is as old as computers themselves. Computers can execute basic arithmetic and Boolean logic very quickly, but rely on input to do something useful. For example, instructing a computer to add one plus one produces the result of two. The speed at which the result is generated is dependant upon the speed of the electrical device doing the calculation, and the speed at which the instruction and data is received and stored. If a user manually enters the command, the time it takes to produce a result is a function of how fast the user can type and how fast the result can be read. Very quickly the speed of the electrical devices doing these calculations outpaced even the fastest typist; thus the field of database was begun. In its simplest form, a database is a repository for the storage, and retrieval of information. In the beginning these systems simply provided batch input for programs, and stored the output. Over the years the use of computing technologies expanded from missile trajectory programs, to accounting, to games. Likewise, the database has evolved from an internal function which supports the execution of programs, to a stand-alone system.

Today's database still provides the same, crucial role of storing and retrieving data, but now it is a stand alone application. Client applications connect to the database via network, or by other programmatic means, to store and retrieve data. The form of these requests most commonly takes the form of Structured Query Language (SQL). Based on the mathematical discipline of set theory, client applications can now define a set of information, and an action to apply to the set. For example, the following SQL returns the title of all patents invented by Cary Jardin:

SELECT TITLE FROM PATENT TABLE_WHERE INVENTOR =‘Cary Jardin’;

With SQL applications, users can store and retrieve information from a database in a precise, logical, and standard way. Unfortunately, like the typist inputting too slow, applications that rely on a database for storage and retrieval of information are only as fast as the database can provide the information. This is known as a bottleneck; a system or unit that hinders the performance of the entire solution. Bottlenecks never go away, they just move. First, it was the typist not being able to enter commands fast enough. For the purpose of this invention the database is the bottleneck.

### SUMMARY OF THE INVENTION

The present invention disclosed and claimed herein, in one aspect thereof, comprises a method of increasing database performance by incrementally adding more compute resources. Another object of the invention is to provide a method for traditional database systems to utilize main memory database technologies.

### DESCRIPTION OF THE FIGURES

FIG. 1 illustrates a block diagram of the subject system for database request handling to accomplish database acceleration in connection with the subject invention; and

FIG. 2 illustrates an overall system architecture in which the master database system is disposed in a network in front of the slave database server and a client to accomplish the database acceleration.

### DETAILED DESCRIPTION OF THE INVENTION

Constructing a master and slave database relationship between a persistent database, and a volatile system is a very difficult and novel task. It starts by configuring the master database to utilize data not stored in a native, or local format. One method of achieving this configuration is to utilize a master database system with what is known in the field as heterogeneous table support; this ability allows the master database to access information not stored in local, or native format. Another method to achieve the master and slave database relationship is to modify the master database application to accept a prefix for tables not locally or natively stored, and a method associated with the prefix to obtain the requested information from the specified location. In ANSI SQL (Structured Query Language) this would be achieved by fully specifying the name space for each table; “data source provider”. “database name”. “table name.” One such commercially available data that supports this notation and capability is Microsoft SQL Server.

Once the master server has been configured with a slave database association, all requests for information retrieval with the “foreign” prefix specified will be delegated to the slave server for processing. Additionally, all information storage requests with the “foreign” prefix specified will be delegated to the slave server for processing which is not the objective of the current patent. For this reason, the master database must be configured with a method to locally store all provided information as well as delegate the information storage to the slave system. In this way, both machines contain identical copies of the stored information with the stored master information used for reliable persistent storage, and the slave system used for high speed information retrieval. One method of achieving this configuration is to utilize what is known as “views” and “triggers” on the master database, both of which are provided by commercial database systems such as Microsoft SQL server and Oracle. A “view” is a name space abstraction for the source of requested information. For example, information being requested from a “customer” table can be re-directed to a “new-customer” table. In this way, the user request can be routed to the most appropriate or desired source. A “trigger” provides a mechanism to execute a programmatic method at the time of an information state change. For example, when a request for storing a new customer date into the system is received, the database server executes any defined “triggers” to override the default behavior of the system. Thus, instead of saving the new customer information in the customer table, the information can be save into a “pending-customer” location for future processing. In the context of the current invention, views are used to hide the existence of the slave database system, and triggers are used to store the information on the master and slave systems from a single request for information storage. This is achieved by defining a view for each desired table in the master database system. The view can be created with an unique name, or the original table can be renamed and the view can assume the original table name. In the later instance, applications written to access the master database server can utilize the facilities of the slave system without modification. Creation of a view consists of a view name, and a definition of the information contained in the view. For the purpose of this invention, the view defended to contain the slave database system information. The defined view configuration provides ability to route information retrieval requests through the master system for fulfillment to the slave system for fulfillment. Definition of a trigger on information storage requests completes the system. The definition of a trigger consists of an associated table or view, and the action to take. For the purpose of this invention, a trigger is created to be associated with a state change on the newly defined view. In this way, the defined trigger will be executed every time a request for information to be stored into the defined view. The application logic defined within the newly created trigger will store the requested information into both the master database and the slave system from a single user request.

As previously mentioned, the current invention utilizes a main memory slave system to enhance the performance of user information retrieval requests. With both the view and trigger defined on the master system, users accessing information will be utilizing the performance of the slave database system. If the slave system should loose power or loose the stored information within, the master system can manually or programmatically modify the defined view to route requests to local or native resources. In this way, the reliability of existing database systems can be used in cooperation with less reliable, enhanced performance systems such as main memory databases.

Although the preferred embodiment has been described in detail, it should be understood that various changes, substitutions and alterations can be made therein without departing from the spirit and scope of the invention as defined by the appended claims.

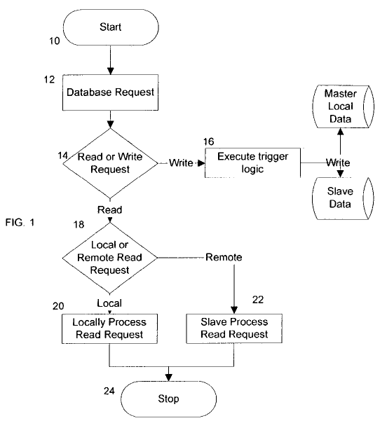

Turning to FIG. 1, an overall flow diagram of a database acceleration A accomplished in connection with the subject system is disclosed. The basic flow commences at start block 10, from which progress is made to block 12 at which point the database request is received by the master database system. A determination is made at decision block 14 to determine whether the request is an information retrieval request, read operation, or information storage request, write operation. This determination is suitably accomplished by analysis of database requests, or other suitable criteria as dictated by the particular acceleration application.

A write determination at decision block 14 causes progress to block 16. At this point, the defined “trigger” application logic is invoked to duplicate the write operation to both the local, master, data storage and the remote, slave, data storage. Flow progresses back to block 14 to determine whether a subsequent request meets the above test, as noted above.

A read determination at decision block 14 causes progression to block 18. At this point, a database request is determined to be a local request, or a remote request. A local determination at decision block 18 causes progress to block 20. At this point the default master database behavior is invoked to retrieve the requested information.

A remote determination at decision block 18 causes progression to block 22. At this point the database request is forwarded to the remote slave system for retrieval of the requested information.

Once completion of all relevant requests has been completed, the acceleration A is completed, and the system proceeds to stop at termination block 20.

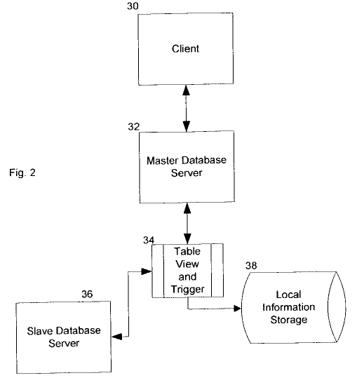

Turning next to FIG. 2, a database client environment in which a preferred embodiment database acceleration is provided. A client 30 connects to the database server through network, Application Programming Interface, or other means suitable for sending and receiving requests to the database server. The Master Database Server 36 receives the client requests and routes information retrieval requests directly to the slave database server through any internally supporting methods such as views and triggers 34. Information storage requests are processed through any internally supporting methods such as views and triggers 34 and then sent to local persistent storage 38, and sent to the slave database server 36 to maintain a replicated image of the master local storage 38.

What is claimed is:

1. A method for cooperative database performance comprising:
a) database system with heterogeneous query support (master); and
b) main memory database system (slave).
